(19) United States
(12) Patent Application Publication
(10) Pub. No.: US 2013/0272841 A1
(43) Pub. Date: Oct. 17, 2013

(54) FLUID TURBINE WITH INTEGRATED PASSIVE YAW

(71) Applicant: FLODESIGNE WIND TURBINE CORP., Waltham, MA (US)

(72) Inventors: Søren Hjort, Silkeborg (DK); Rune Rubak, Silkeborg (DK)

(73) Assignee: FLODESIGN WIND TURBINE CORP., Waltham, MA (US)

(21) Appl. No.: 13/861,025

(22) Filed: Apr. 11, 2013

Related U.S. Application Data
(60) Provisional application No. 61/622,815, filed on Apr. 11, 2012.

(51) Int. Cl. F03D 1/04

(52) U.S. Cl. CPC F03D 1/04
USPC 415/1; 415/4.3

(57) ABSTRACT

Example embodiments are directed to shrouded fluid turbines that include a turbine shroud and a rotor. The turbine shroud includes a an inlet, an outlet and a plurality of mixer lobes circumferentially spaced about the outlet. The rotor can be disposed within the turbine shroud and downstream of the inlet. The rotor includes a hub and at least one rotor blade engaged with the hub. The shrouded fluid turbines further include a passive yaw system for regulating a yaw of the shrouded fluid turbine. The shrouded fluid turbine defines a center of gravity and a center of pressure. The center of gravity can be offset from the center of pressure. Example embodiments are also directed to methods of yawing a shrouded fluid turbine.

### CROSS-REFERENCE TO RELATED APPLICATIONS

The present application claims the benefit of a U.S. provisional patent application entitled “Fluid Turbine With Integrated Passive Yaw” which was filed on Apr. 11, 2012, and assigned Ser. No. 61/622,815. The entire content of the foregoing provisional application is incorporated herein by reference.

### TECHNICAL FIELD

The present disclosure relates to turbines for power generation and, in particular, to shrouded fluid turbines with an integrated passive yaw system for the purpose of yawing the shrouded fluid turbines into the fluid-flow direction and protecting the shrouded fluid turbines and yaw equipment in the event of excessive fluid speeds, loss of connection to grid power and other system protection modes.

### BACKGROUND

Conventionally, horizontal axis wind turbines (HAWTs) used for power generation include one to five open blades arranged like a propeller and a rotor attached at a hub. The blades are generally mounted to a horizontal shaft attached to a gear box which drives a power generator. Typically, the gearbox and generator equipment are further housed in a nacelle. The blades rotate due to the wind and drive the power generator to produce electricity.

However, the position of the HAWT relative to wind direction must be maintained to effectively drive the power generator. Turbines are typically mounted on the main vertical support structure at the approximate center of gravity of the turbine and near the center of pressure.

Turbine passive yaw characteristics employ aerodynamic structures to yaw the turbine into the wind. Larger turbines conventionally employ mechanical yaw systems as they are engaged with a support structure about a pivot axis that is located near the center of gravity and also resides near the center of pressure. The turbine configurations in which the location of the pivot axis is aligned with respect to the location of the center of pressure generally result in thrust forces on the turbine that do not appropriately yaw the turbine to the desired direction. Thus, continuous control from an active yaw component is generally required.

### SUMMARY

In accordance with example embodiments of the present disclosure, shrouded fluid turbines, e.g., shrouded liquid turbines, shrouded air turbines, and the like, are taught that efficiently and effectively position the shrouded fluid turbine relative to wind direction by passive and active yaw systems. A passive yaw system which can be capable of yawing the shrouded turbine appropriately into the wind can be referred to as a functional-passive yaw system or a continuous-passive yaw system. The employment of a functional-passive yaw system without the use of an active yaw system can be referred to as full-passive yaw. An active yaw system required to yaw the shrouded turbine to the desired direction can be referred to as a controlling-active yaw system or a momentary-active yaw system. A system that utilizes functional-passive yaw in combination with the active yaw system can be referred to as supporting-active yaw. A cut-in fluid velocity of a shrouded turbine generally defines the fluid velocity at which the shrouded turbine can begin generating electrical energy. The cut-out fluid velocity of a shrouded turbine generally defines the point at which the shrouded turbine is shut down to prevent damage to electrical generation and mechanical components due to excessive fluid velocity that would result in excessive rotor speed.

The shrouded turbines discussed herein, e.g., shrouded fluid turbines that include mixer-ejector turbines (MET), as well as shrouded turbines free of an ejector shroud, generally engage with a support structure near the center of gravity of the shrouded turbine while pivoting about the support structure about an axis that is offset from the center of pressure of the shrouded turbine. Pivoting about an axis that is offset from the center of pressure causes the shrouded turbine to have a tendency to move to a position in which the center of pressure remains downstream of the pivot axis. This provides passive yaw when the fluid stream is of sufficient strength, e.g., from cut-in fluid velocity to cut-out fluid velocity. Although the effects of passive yaw may be present in most fluid velocities, a braking system can be included to prevent the function of the passive yaw system before cut-in fluid velocity and after cut-out fluid velocity.

An active yaw system, e.g., a motor driven yaw system, can be employed to rotate the nacelle of a shrouded fluid turbine into the direction of the fluid, e.g., air, liquid, and the like. The active yaw system can be disposed between a tower top and the nacelle. For example, the components of the active yaw system may be situated in the nacelle or in the tower. The active yaw system can include at least one adjustment drive, which may be equipped with a gearbox, and a yaw bearing engaged with a ring gear. After completed yaw adjustment of the nacelle, the nacelle can be immobilized by the brake units which generate the holding torque that is used for the nacelle.

Although the aerodynamic principles of the shrouded fluid turbines discussed herein are with respect to air, it should be understood that the aerodynamic principles of the shrouded fluid turbines are not restricted to air and apply to any fluid, e.g., any liquid, gas, or combinations thereof, and therefore including water as well as air. For example, the aerodynamic principles of a mixer-ejector turbine apply to hydrodynamic principles in a shrouded mixer ejector water turbine. Further, for the purpose of convenience, the present example embodiments are described in relation to shrouded turbine applications, both mixer-ejector turbines and shrouded turbines free of an ejector shroud. However, it should be understood that such description is solely for convenience and clarity and is not intended to be limiting in scope.

In accordance with example embodiments of the present disclosure, shrouded fluid turbines, e.g., shrouded fluid turbines that include mixer-ejector turbines, as well as shrouded turbines free of an ejector shroud, are taught. The shrouded turbines can include a turbine shroud with mixing elements surrounding a rotor. In some embodiments, the shrouded turbine can further include an ejector shroud in fluid communication with the mixing elements of the turbine shroud. The shrouded fluid turbines discussed herein include an aerodynamically contoured turbine shroud with an inlet and a rotor downstream of the inlet having one or more rotor blades engaged with a hub. The hub can be further engaged with a shaft that is engaged with electrical generation equipment housed in a nacelle. In some embodiments, the shrouded fluid turbine can be a single shroud fluid turbine and can include a ring of mixer lobes. In some embodiments, the shrouded fluid turbine can be a double shroud fluid turbine and can include an ejector shroud surrounding the ring of mixer lobes. The mixer lobes extend downstream of the rotor blades. The mixer lobes can also extend downstream and toward the ejector shroud. The shrouded fluid turbine can include engagement structures between the shrouded turbine and the support structure which include a combination of momentary-active and continuous-passive yaw systems.

In accordance with example embodiments of the present disclosure, shrouded fluid turbines are taught that include a turbine shroud which includes an inlet, an outlet and a plurality of mixer lobes circumferentially spaced about the outlet. The shrouded fluid turbines further include a rotor disposed within the turbine shroud and downstream of the inlet. The rotor includes a hub and at least one rotor blade, e.g., one, two, three, four, five, and the like, rotor blades engaged with the hub. The shrouded fluid turbines can include a passive yaw system for regulating a yaw of the shrouded fluid turbine. The shrouded fluid turbines define a center of gravity and a center of pressure. The center of gravity can be offset from the center of pressure.

The shrouded fluid turbine can include an ejector shroud surrounding the plurality of mixer lobes. The ejector shroud defines an ejector shroud inlet and an ejector shroud outlet. The ejector shroud outlet is located downstream of the ejector shroud inlet. In some embodiments, at least one of the turbine shroud and the ejector shroud can include faceted sides. The plurality of mixer lobes can extend downstream of the ejector shroud inlet. The shrouded fluid turbine includes a support structure for connecting the turbine shroud to the ejector shroud. The support structure can provide vertical stabilization to the ejector shroud relative to the turbine shroud and provides yaw characteristics that support passive yaw of the shrouded fluid turbine. The shrouded fluid turbine includes a nacelle including therein electrical generation equipment and a support structure rotationally engaged with the shrouded fluid turbine.

In addition to the passive yaw system, the shrouded fluid turbine can include an active yaw system for yawing the shrouded fluid turbine into a fluid-flow direction. The passive yaw system can be, e.g., a continuous-passive yaw system. The active yaw system can be, e.g., a momentary-active yaw system, a controlling-active yaw system, a supporting-active yaw system, or combinations thereof. The passive yaw system can be engaged from a cut-in fluid velocity to a cut-out fluid velocity. The controlling-active yaw system can be engaged from the cut-in fluid velocity to a predetermined fluid velocity range, e.g., between approximately 8 m/s and approximately 12 m/s. A combination of the passive yaw system and the supporting-active yaw system can be engaged between the predetermined fluid velocity range, e.g., between approximately 8 m/s and approximately 12 m/s, and the cut-out fluid velocity. The active yaw system can further include brakes. The brakes can automatically disengage during a loss of grid power to the shrouded fluid turbine.

In accordance with example embodiments of the present disclosure, methods of yawing a shrouded fluid turbine are taught that include providing a shrouded fluid turbine. The shrouded fluid turbine includes a turbine shroud including an inlet, an outlet and a plurality of mixer lobes circumferentially spaced about the outlet. The shrouded fluid turbine further includes a rotor disposed within the turbine shroud and downstream of the inlet. The rotor includes a hub and at least one rotor blade engaged with the hub. The shrouded fluid turbine includes a passive yaw system for regulating a yaw of the shrouded fluid turbine. The shrouded fluid turbine defines a center of gravity and a center of pressure. The center of gravity can be offset from the center of pressure. The methods include yawing the shrouded fluid turbine via the passive yaw system. The methods further include providing an active yaw system. The passive yaw system and the active yaw system yaw the shrouded fluid turbine into a fluid-flow direction. The passive yaw system can be a continuous-passive yaw system and the active yaw system can be at least one of a momentary-active yaw system, a controlling-active yaw system and a supporting-active yaw system. The methods include engaging the passive yaw system form a cut-in fluid velocity to a cut-out fluid velocity, engaging the controlling-active yaw system from the cut-in fluid velocity to a predetermined fluid velocity range, and engaging a combination of the passive yaw system and the supporting-active yaw system between the predetermined fluid velocity range and the cut-out fluid velocity.

Other objects and features will become apparent from the following detailed description considered in conjunction with the accompanying drawings. It is to be understood, however, that the drawings are designed as an illustration and not as a definition of the limits of the invention.

### BRIEF DESCRIPTION OF THE DRAWINGS

To assist those of skill in the art in making and using the disclosed shrouded fluid turbines and associated methods, reference is made to the accompanying figures, wherein:

FIG. 1 is a front perspective view of an example shrouded fluid turbine according to the present disclosure;

FIG. 2 is a side view of an example shrouded fluid turbine including a center of gravity, a center of pressure and a pivot point according to the present disclosure;

FIG. 3 is a perspective and a side detailed view of an example active yaw system according to the present disclosure;

FIG. 4 is a diagram illustrating the relationship between fluid-flow velocities and employment of passive and active yaw systems according to the present disclosure;

FIG. 5 is a front perspective view of an example shrouded fluid turbine including vertical stabilizers integrated with ejector support struts and with a nacelle support structure according to the present disclosure;

FIG. 6 is a rear perspective view of the example shrouded fluid turbine of FIG. 5;

FIG. 7 is a front perspective view of an example shrouded fluid turbine including vertical stabilizers integrated with ejector support struts and with a nacelle support structure according to the present disclosure;

FIG. 8 is a rear perspective view of the example shrouded fluid turbine of FIG. 7;

FIG. 9 is a side view of an example shrouded fluid turbine defining a shroud centerline oriented offset from a perpendicular position relative to a tower centerline;

FIG. 10 is a front perspective view of an example shrouded fluid turbine according to the present disclosure;

FIG. 11 is a side view of an example shrouded fluid turbine including a center of gravity, a center of pressure and a pivot point according to the present disclosure;

FIG. 12 is a front perspective view of an example shrouded fluid turbine according to the present disclosure;

FIG. 13 is a rear perspective view of an example shrouded fluid turbine according to the present disclosure;

FIG. 14 is a front perspective view of an example shrouded fluid turbine according to the present disclosure;

FIG. 15 is a rear perspective view of an example shrouded fluid turbine according to the present disclosure;

FIG. 16 is a side view of an example shrouded fluid turbine defining a shroud centerline oriented offset from a perpendicular position relative to a tower centerline;

FIG. 17 is a front perspective view of an example shrouded fluid turbine according to the present disclosure;

FIG. 18 is a rear perspective view of an example shrouded fluid turbine according to the present disclosure;

FIG. 19 is a side cross-sectional view of an example shrouded fluid turbine including a center of gravity, a center of pressure and a pivot point according to the present disclosure;

FIG. 20 is a front perspective view of an example shrouded fluid turbine according to the present disclosure;

FIG. 21 is a rear perspective view of an example shrouded fluid turbine according to the present disclosure; and

FIG. 22 is a side cross-sectional view of an example shrouded fluid turbine including a center of gravity, a center of pressure and a pivot point according to the present disclosure.

### DESCRIPTION

Although specific terms are used in the following description, these terms are intended to refer to particular structures in the drawings and are not intended to limit the scope of the present disclosure. It is to be understood that like numeric designations refer to components of like function.

The term “about” or “approximately” when used with a quantity includes the stated value and also has the meaning dictated by the context. For example, it includes at least the degree of error associated with the measurement of the particular quantity. When used in the context of a range, the term “about” or “approximately” should also be considered as disclosing the range defined by the absolute values of the two endpoints. For example, the range “from about 2 to about 4” or “from approximately 2 to approximately 4” also discloses the range “from 2 to 4.”

The shrouded fluid turbines discussed herein, e.g., shrouded fluid turbines that include mixer-ejector turbines, as well as shrouded turbines free of an ejector shroud, provide advantageous systems for generating power from fluid currents. The fluid currents discussed herein may be, but are not limited to, e.g., gas currents, liquid currents, such as air and water. In example embodiments of shrouded turbines free of an ejector shroud, the turbine shroud encloses a rotor which extracts power from a primary fluid stream. The turbine shroud brings fluid flow through the rotor and allows energy extraction due to the flow rate. The structure or surfaces of the turbine shroud can also be used as an integrated lightning protection system for the shrouded fluid turbine.

In example embodiments of the shrouded mixer-ejector turbines which include an ejector shroud, the shrouded turbines can include tandem cambered shrouds and a mixer/ejector pump. The turbine shroud encloses a rotor which extracts power from a primary fluid stream. The tandem cambered shrouds and ejector bring more flow through the rotor allowing more energy extraction due to higher flow rates. The mixer/ejector pump transfers energy from the bypass flow, that is, fluid flow that flows past the exterior of the turbine shroud, to the rotor wake flow allowing higher energy per unit mass flow rate through the rotor. These effects enhance the overall power production of the example shrouded turbine system. The structure or surfaces of the shroud(s) can also be used as an integrated lightning protection system for the shrouded fluid turbine.

The term “rotor” is used herein to refer to any assembly in which one or more blades are attached to a shaft and able to rotate, allowing for the extraction of power or energy from fluid rotating the blades. Example rotors can include a propeller-like rotor or a rotor/stator assembly. Any type of rotor may be enclosed within the turbine shroud in the shrouded turbine of the present disclosure.

The leading edge of a turbine shroud may be considered the front of the shrouded fluid turbine, and the trailing edge of an ejector shroud may be considered the rear of the shrouded fluid turbine. Each of the turbine shroud and the ejector shroud can define an inlet and an outlet, the outlet being located downstream of the inlet. In particular, a first component of the shrouded fluid turbine located closer to the front of the shrouded turbine may be considered “upstream” of a second component located closer to the rear of the shrouded turbine. Thus, the second component is “downstream” of the first component.

The present disclosure relates to a shrouded fluid turbine system, method and apparatus for yawing the shrouded turbine into the appropriate direction with respect to the fluid direction that employs a functional-passive yaw system in combination with controlling-active and supporting-active yaw systems. An example embodiment relates, in general, to a shrouded fluid turbine including an annular airfoil, referred to herein as a ringed or circular turbine shroud, that surrounds a rotor. Other example embodiments may further include an ejector shroud that surrounds the exit, i.e., outlet, of the turbine shroud. Although discussed herein as a circular or ring shroud, it should be understood that in some example embodiments, other configurations, e.g., square, rectangular, oval, and the like, of the shrouds can be used. In some example embodiments, the turbine shroud can include a set of mixing lobes along the trailing edge, i.e., outlet of the turbine shroud. In some example embodiments, the set of mixing lobes can be in fluid communication with the inlet of an ejector shroud. In some example embodiments, the turbine shroud includes an annular leading edge that transitions to a faceted trailing edge. The faceted trailing edge can, in turn, be in fluid communication with a trailing edge of a faceted ejector shroud. In some example embodiments, an annular turbine shroud having a constant cross-section can be in fluid communication with an annular ejector shroud having a constant cross-section. In example embodiments including a turbine shroud free of an ejector shroud, the mixer lobes provide an increased fluid velocity near the inlet of the turbine shroud at the cross-sectional area of the rotor plane. In example embodiments including a turbine shroud and an ejector shroud, the mixer lobes and the ejector shroud form a mixer-ejector pump which provides increased fluid velocity near the inlet of the turbine shroud at the cross-sectional area of the rotor plane. The mixer-ejector pump further energizes the wake behind the rotor plane. The combination of the effects of the mixing lobes and the energized wake provides a rapidly-mixed shorter wake compared to the wake of non-shrouded horizontal axis wind turbines.

In some embodiments, the turbine shroud, the mixer lobes, the faceted trailing edge or annular trailing edge, and the ejector shroud form a mixer-ejector pump which provides increased fluid velocity near the inlet of the turbine shroud at the cross-sectional area of the rotor plane. The mixer/ejector pump can transfer energy from the bypass flow to the rotor wake flow by both axial and stream-wise voracity, thereby allowing higher energy-extraction per unit mass flow rate through the rotor. The increased flow through the rotor, combined with increased mixing, can result in an increase in the overall power production of the shrouded fluid turbine system.

In general, the shrouded or ducted fluid turbines discussed herein provide increased efficiency in generating electrical energy from fluid currents while providing increased surface area in those fluid currents. The increased surface area can result in increased loading on the structural components of the shrouded fluid turbine. This increased loading provides radial directional forces that yaw the shrouded turbine into the fluid flow. A passive yaw system mitigates the negative effects of the increased structural loading by allowing the shrouded turbine to rotate to a position of least fluid-flow resistance. In some example embodiments, aerodynamic forms, such as vertical stabilizers, may be integrated into the turbine shroud and the ejector shroud to provide additional yaw stabilization. Vertical aerodynamic surfaces, integrated into the shroud(s), can provide an augmentation to the integrated passive yaw system.

The shrouded turbine and shrouds discussed herein can provide a platform for an integrated passive yaw and an active yaw system. As will be discussed below, active yawing can be provided by geared drive units engaged with a slew ring between a bearing race between the tower and shrouded turbine. Passive yawing can be deployed by disengaging at least one clutch that is integrated into a gear mechanism(s) and used in fluid-flow velocities below the cut-in fluid-flow velocity, above the cut-out fluid-flow velocity and during grid loss or other protection system modes. A passive yaw damping system can be integrated into the yaw system of the example shrouded turbine which prevents over-torqueing caused by, e.g., excessive fluid speed, fluid gusts, and the like.

The example shrouded turbine can be engaged with the support structure near the center of gravity of the shrouded turbine while pivoting about the support structure about an axis that is offset from the center of pressure. The center of pressure generally defines the point on the shrouded turbine where the total sum of the pressure field causes a force and no moment-force about that point. The center of pressure of a shrouded turbine is typically near the downwind portion of the rotor plane. The point at which the support structure engages the shrouded turbine is typically behind the rotor plane at the nacelle. Thus, the shrouded turbine can provide passive yaw at most fluid-flow velocities. The passive yaw system can thereby be activated by disengaging at least one clutch below the shrouded turbine cut-in velocity and continues to assist in yawing the shrouded turbine through the cut-out velocity when the at least one clutch or break is engaged to shut down the shrouded turbine. The active yaw system can be employed to control yawing of the shrouded turbine in fluid-flow velocities within the range from the cut-in speed to a predetermined fluid velocity range. The predetermined fluid velocity range can be, e.g., between approximately 8 m/s and approximately 12 m/s. In some example embodiments, rather than a predetermined fluid velocity range, a predetermined fluid velocity of, e.g., approximately 10 m/s, can be used. This type of active yaw system can be referred to as controlling-active yaw and can be used to yaw the shrouded turbine when the fluid-flow velocity is not sufficient for the passive yaw system to move the shrouded turbine. A combination of the active-yaw system and the passive-yaw system can be employed from the predetermined fluid velocity range to the cut-out fluid-flow velocity. The predetermined fluid velocity range can be, e.g., between approximately 8 m/s and approximately 12 m/s. In some example embodiments, rather than a predetermined fluid velocity range, a predetermined fluid velocity of, e.g., approximately 10 m/s, can be used. In this fluid-flow velocity range the forces on the shrouded turbine are sufficient for the passive yaw system to move the shrouded turbine. This type of yaw control can be referred to as supporting-active yaw in combination with functional-passive yaw.

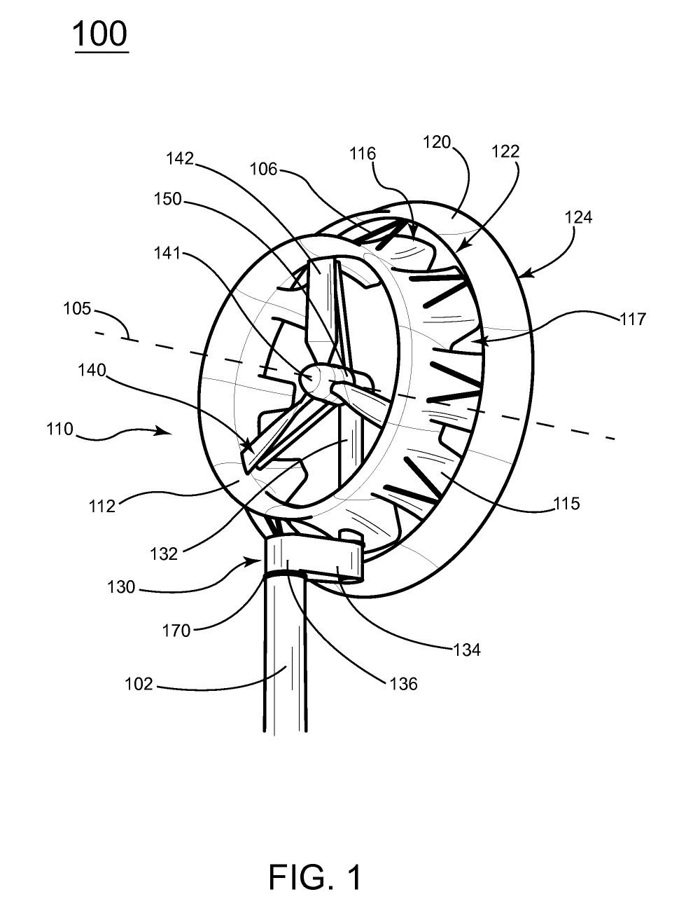

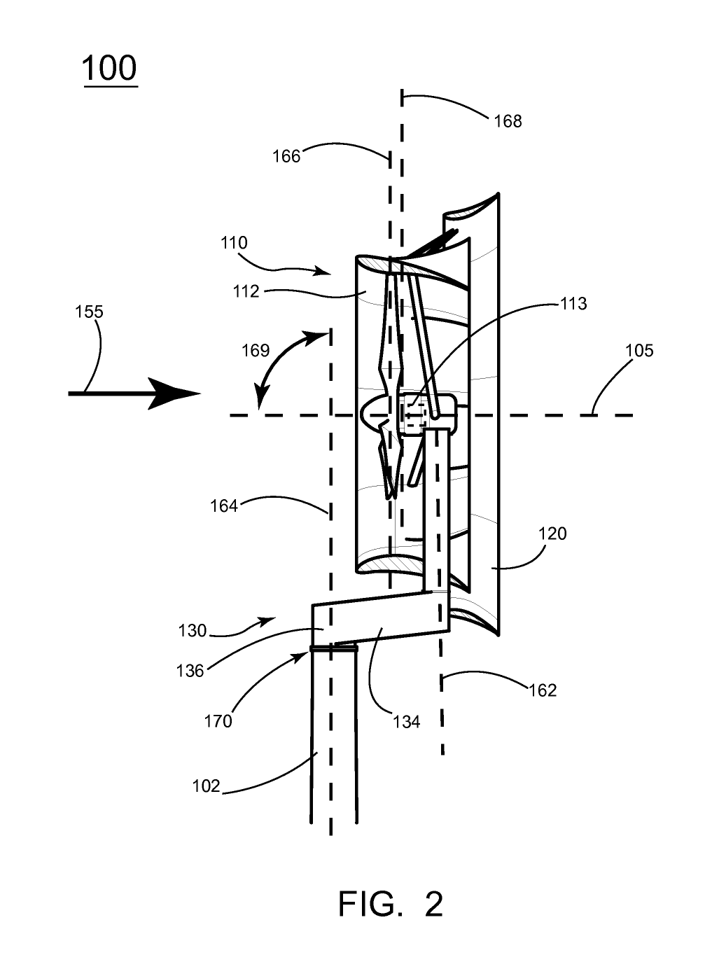

Turning now to FIG. 1, a perspective view of one example embodiment of a shrouded fluid turbine 100 (hereinafter “shrouded turbine 100”) is provided. Numerous alternative shrouded or ducted fluid turbines may employ the features of the present invention. Thus, as would be understood by those of ordinary skill in the art, the example embodiment of shrouded turbine 100 illustrated in FIG. 1 is not intended to be limiting in scope and is for illustrative purposes. FIG. 2 is a side view of the shrouded turbine 100 and illustrates the location of a center of gravity 162, a center of pressure 168 and a pivot axis 164 of the shrouded turbine 100 for the passive yaw system.

With reference to FIGS. 1 and 2, in this example embodiment, the shrouded turbine 100 includes a turbine shroud 110, a nacelle body 150, a rotor 140 and an ejector shroud 120. As will be discussed in greater detail below, in some example embodiments, the shrouded turbine 100 can be fabricated without the ejector shroud 120 and the components associated with the ejector shroud 120.

The turbine shroud 110 defines a front end 112, e.g., an inlet, a leading edge, and the like. The turbine shroud 110 also defines a rear end 116, e.g., an outlet, an exhaust end, a trailing edge, and the like. The rear end 116 defines outward curving lobes 117 and inward curving lobes 115 configured and dimensioned to mix the fluid flowing through the turbine shroud 110. The ejector shroud 120 defines a front end 122, e.g., an inlet, a leading edge, and the like, and a rear end 124, e.g., an outlet, an exhaust end, a trailing edge, and the like. Support members 106 can be used as depicted in FIGS. 1 and 2 to connect the turbine shroud 110 to the ejector shroud 120 and provide structural support to the ejector shroud 120 relative to the turbine shroud 110. In single shroud embodiments, the shrouded turbine 100 further includes a tower 102 configured and dimensioned to rotationally support the assembly of the turbine shroud 110, the rotor 140, and the associated components thereon. In dual shroud embodiments, the tower 102 can be configured and dimensioned to rotationally support the assembly of the turbine shroud 110, the rotor 140, the ejector shroud 120, and the associated components thereon.

The rotor 140, the turbine shroud 110 and the ejector shroud 120 can be coaxially aligned relative to each other, i.e. the rotor 140, the turbine shroud 110 and the ejector shroud 120 share a common central axis 105. Thus, the rotor 140 can be centrally positioned within the turbine shroud 110 along the central axis 105. The rotor 140 can surround the nacelle body 150 and includes a central hub 141 positioned coaxially with the central axis 105. The nacelle body 150 can include therein electrical generation equipment 113. The rotor 140 also includes one or more blades 142 which include a proximal end connected to the central hub 141 and a distal end extending in the direction of the inner walls of the turbine shroud 110. The central hub 141 can be rotationally engaged with the nacelle body 150. The shrouded turbine 100 further includes a support structure 130 which includes an upper vertical member 132 engaged with the nacelle body 150 at the distal end and with a predominantly horizontal portion 134 at the proximal end. The horizontal portion 134 can be further engaged with a pivoting structure 136. The pivot point of the pivoting structure 136 can, in turn, be engaged with the upper portion of a tower 102. The engagement between the nacelle body 150, the central hub 141 and the components of the support structure 130 can provide rotational movement between said components to allow the shrouded turbine 100 to yaw with respect to a fluid-flow direction.

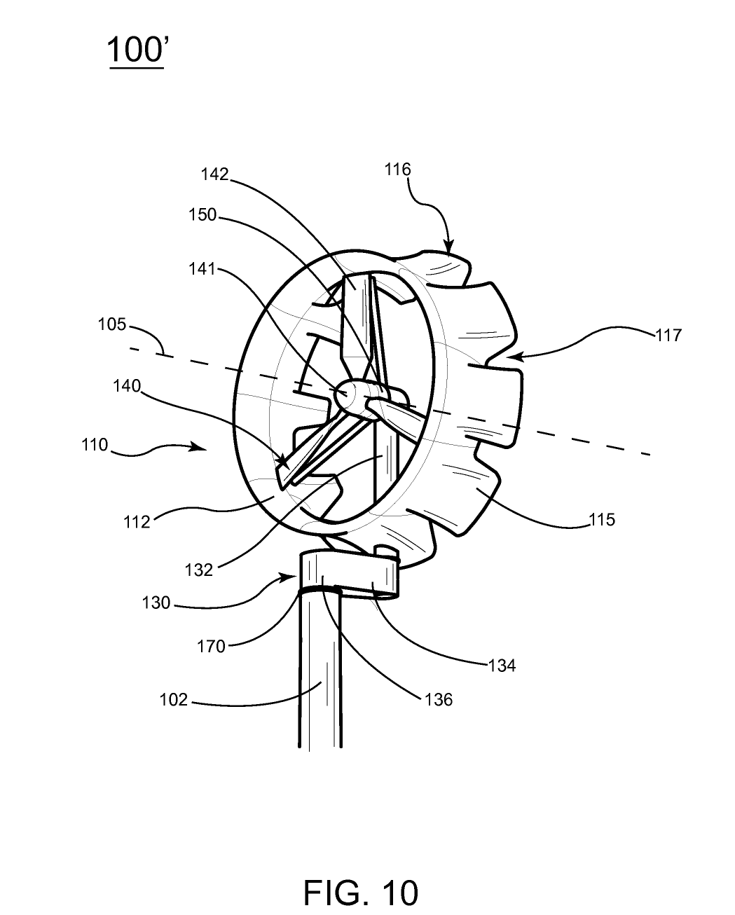

With specific reference to FIG. 2, the locations of the center of gravity 162, the pivot axis 164, the rotor plane 166 and the center of pressure 168 are illustrated with dotted lines representing each respective axis or plane. The center of pressure 168 can be positioned downstream of the rotor plane 166. The pivot axis 164 located at the center of the tower 102 can be offset from the center of pressure 168. In addition, the pivot axis 164 can be positioned at a perpendicular angle relative to the central axis 105 of the shrouded turbine 100, i.e., angle 169 can be approximately 90°. With the center of pressure 168 offset from the pivot axis 164, a fluid stream represented by arrow 155 can exert a force on the shrouded turbine 100 such that the shrouded turbine 100 moves downstream from the pivot axis 164. The positioning of the center of pressure 168 relative to the pivot axis 164 further passively yaws the shrouded turbine 100 such that it faces into the direction of fluid flow. In particular, the location of the pivot axis 164 offset from the center of pressure 168 passively yaws the shrouded turbine 100 to maintain the ejector shroud 120 downstream of the front end 112 of the turbine shroud 110. The passive yawing is equally applicable to dual shroud fluid turbines as depicted in FIGS. 1-9 and 17-22 and single shroud fluid turbines as depicted in FIGS. 10-16. The center of pressure 168 generally defines the point on the shrouded turbine 100 where the total sum of the pressure field causes a force and no moment-force about that point. The center of pressure 168 of a shrouded turbine 100 is typically near the downwind portion of the rotor plane 166. The point at which the support structure 130 engages the shrouded turbine 100 is typically behind the rotor plane 166 at the nacelle 150.

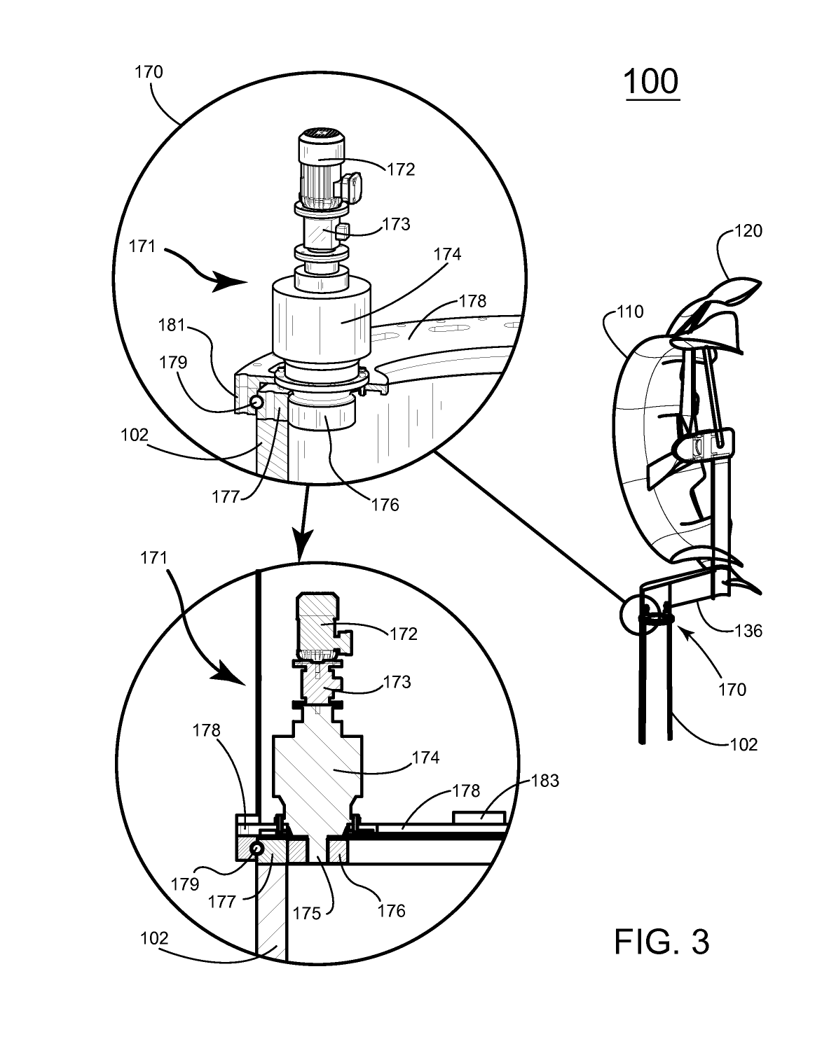

In some example embodiments, in addition to the passive yaw system, shrouded turbine 100 can include an active yaw system. FIG. 3 depicts a perspective and side detailed view of an example active yaw system 170 for shrouded turbine 100. An active yaw system 170 such as that of the example embodiment can be located in the tower 102 of the shrouded turbine 100 and includes at least one motor-gear stack 171. The motor-gear stack 171 illustrated in FIG. 3 can be engaged with the shrouded turbine pivoting-structure 136 and can be rotationally engaged with the tower 102. A motor 172 of the motor-gear stack 171 can be engaged with a clutch 173 that can be further engaged with a transmission 174. The transmission 174 includes a set of reduction gears (not shown) that culminate at a drive shaft 175. The drive shaft 175 can be engaged with the pinion gear 176 and the pinion gear 176 can be engaged with a ring gear 177. The ring gear 177 can be affixed to the tower 102. An outer edge 181 of a top plate 178 can extend around an outer surface of the ring gear 177 and the pinion gear 176 can be positioned against an inner surface of the ring gear 177. In some example embodiments, an O-ring 179 can be maintained between the ring gear 177 and the outer edge 181 of the top plate 178 to prevent debris from entering the active yaw system 170. The motor-gear stack 171 can be engaged to the top plate 178 that can be further engaged with the shrouded turbine pivoting-structure 136. Thus, as the pinion gear 176 is actuated to rotate with, e.g., an actuation mechanism, the active yaw system 170 and, thereby, the shrouded turbine pivoting-structure 136, can be rotated relative to the tower 102 for actively yawing the shrouded turbine 100. In some example embodiments, the active yaw system 170 can include a sensor 183 configured to determine the yawing position of the shrouded turbine 100 relative to the tower 102 and regulate actuation of the active yaw system 170 to appropriately yaw the shrouded turbine 100 relative to the tower 102. The active yawing system 170 is equally applicable to dual shroud fluid turbines as depicted in FIGS. 1-9 and 17-22 and single shroud fluid turbines as depicted in FIGS. 10-16.

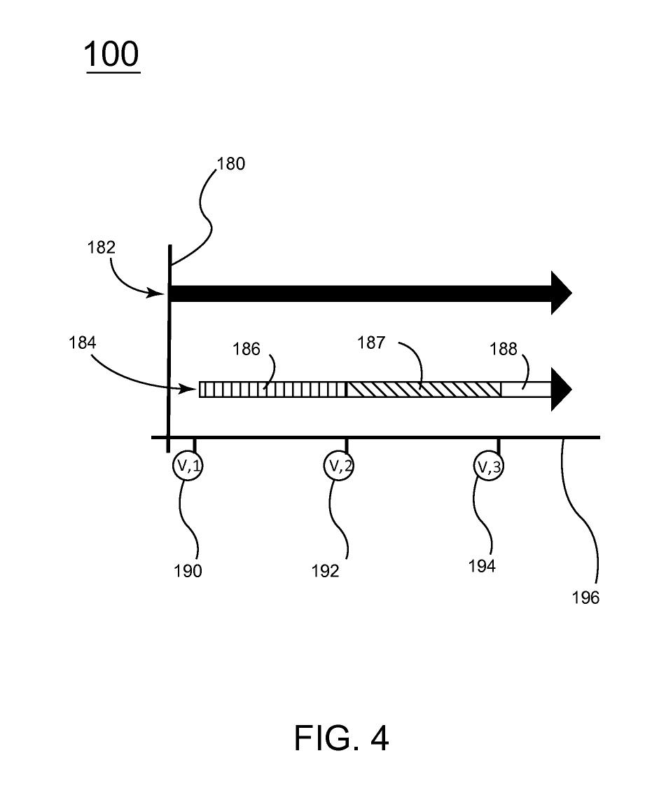

FIG. 4 is a diagram illustrating the relationship between fluid-flow velocities and the employment of passive and active yaw systems of the shrouded turbine 100. However, it should be understood that the diagram of FIG. 4 applies to the relationship between the fluid-flow velocities and the employment of passive and active yaw systems of other example shrouded turbines discussed herein. An application of the passive yaw system is depicted by the solid arrow 182 and an application of the active yaw system is depicted by a segmented arrow 184 located along the vertical axis 180. The horizontal axis 196 represents the cut-in speed of the shrouded turbine V_{,1} 190, the fluid-flow velocity at which rated power occurs V_{,2} 192 and the cut-out fluid-flow velocity V_{,3} 194 along the horizontal axis 196. In the region depicted by the segment 186 in arrow 184, the active yaw controls the direction of the shrouded turbine as the efficacy of the passive system is less than optimal, i.e., the fluid flow velocity is insufficient to passively yaw the shrouded turbine 100. In the region depicted by the segment 187 in arrow 184, a combination of active and passive yaw can be employed. In the region depicted by the segment 188 in arrow 184, the fluid-flow velocity is above the operating range of the shrouded turbine 100. Thus, the shrouded turbine 100 can be placed in a shut-down mode. In particular, in the shut-down mode, the active yaw mechanism can employ one or more clutches or brakes to prevent the shrouded turbine 100 from moving. Some slippage may be allowed such that the passive yaw system can rotate the shrouded turbine 100 into a direction of least resistance against the fluid-flow to prevent excessive loads on the shrouded turbine 100. In some example embodiments, in the event of a loss of power from the grid, one or more clutches or brakes can be automatically disengaged to allow the passive yaw system to function to ensure that the shrouded turbine 100 is not damaged due to, e.g., excessive loads on the shrouded turbine 100 due to increased fluid flow, and the like.

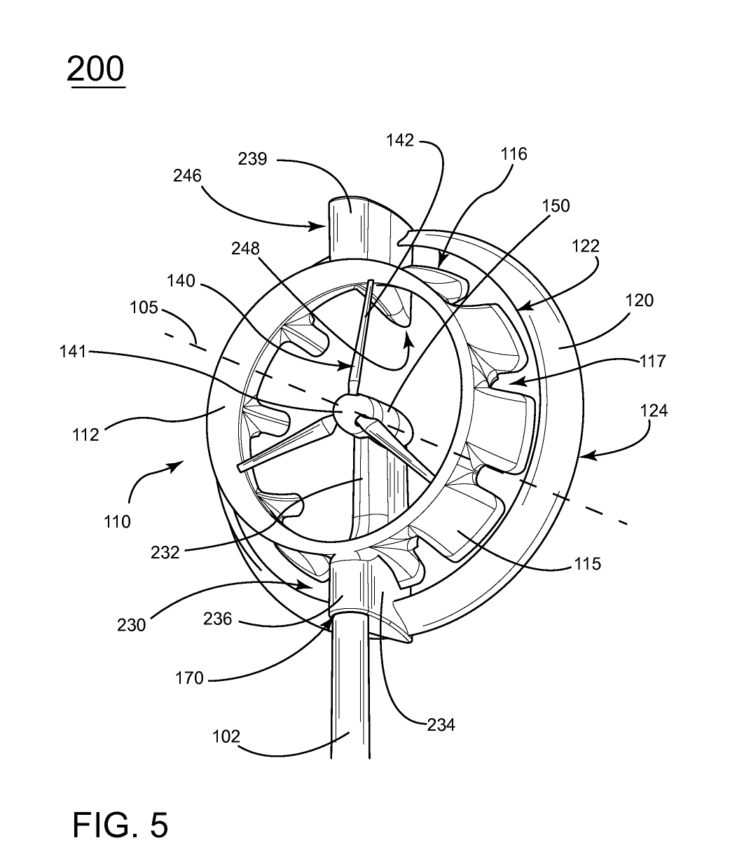

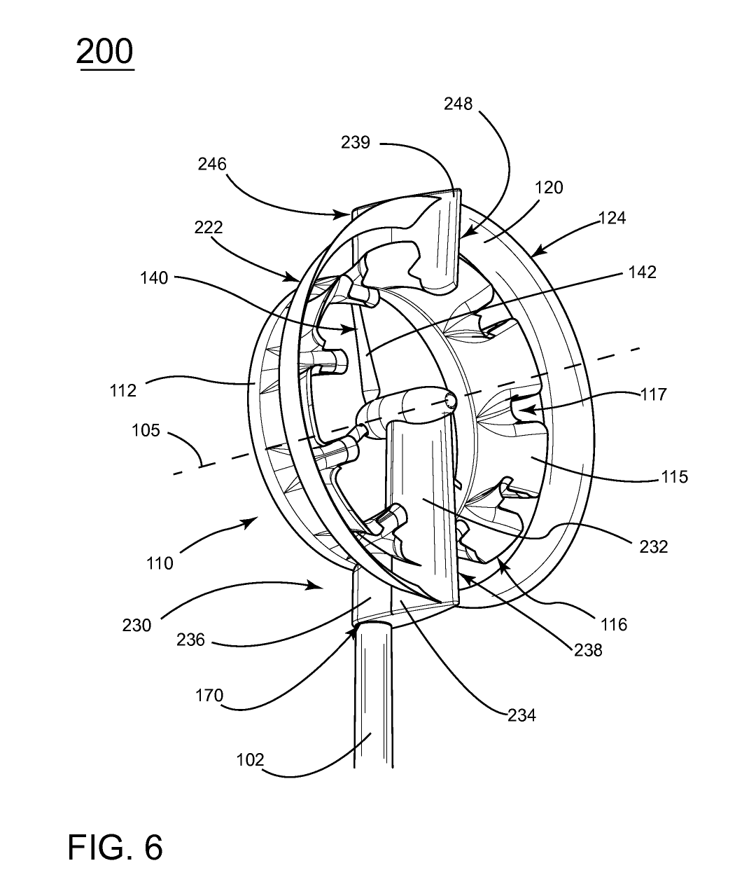

Aerodynamic forms can also be implemented to assist the active yaw system function in the manner described herein. In particular, with reference to FIGS. 5 and 6, front and rear perspective views, respectively, are provided of an example embodiment of a shrouded fluid turbine 200 (hereinafter “shrouded turbine 200”). The example shrouded turbine 200 includes some of the components of the shrouded turbine 100 of FIG. 1 (represented by like numeric designations) and further includes a support structure 230. The support structure 230 includes an upper vertical member 232 that engages the nacelle body 150 at a distal end of the upper vertical member 232 and further engages the horizontal portion 234 at a proximal end of the upper vertical member 232. The horizontal portion 234 can be further engaged with a pivoting structure at the forward pivot point 236. The pivot point 236 can be engaged with the upper portion of the tower 102. As illustrated in FIGS. 5 and 6, the support structure 230 defines an aerodynamic horizontal cross section with a leading edge at the forward pivot point 236 and a trailing edge 238 that is downstream of the leading edge. The aerodynamic cross-sectional form of the support structure 230 can be integral to the upper vertical member 232 and, e.g., provides vertical stabilization, improves the passive yaw function of the shrouded turbine 200, and the like. In some example embodiments, the shrouded turbine 200 can include an additional aerodynamic form 239 positioned at the top of the shrouded turbine 200. The aerodynamic form 239 can provide vertical stabilization to the shrouded turbine 200, e.g., vertical stabilization or structural support between the turbine shroud 110 and the ejector shroud 120, includes passive yaw characteristics, and the like. For example, the passive yaw characteristics can include an aerodynamic cross-section with a leading edge 246 and a trailing edge 248. The aerodynamic cross-section of the aerodynamic form 239 can assist in capturing or directing the flow of fluid through the shrouded turbine 200 such that the shrouded turbine 200 can be oriented in the direction of fluid flow. Although discussed herein as components of the shrouded turbine 200, it should be understood that a single shroud turbine, i.e., a shrouded turbine including a turbine shroud 110 and no ejector shroud 120, can also include the support structures discussed herein.

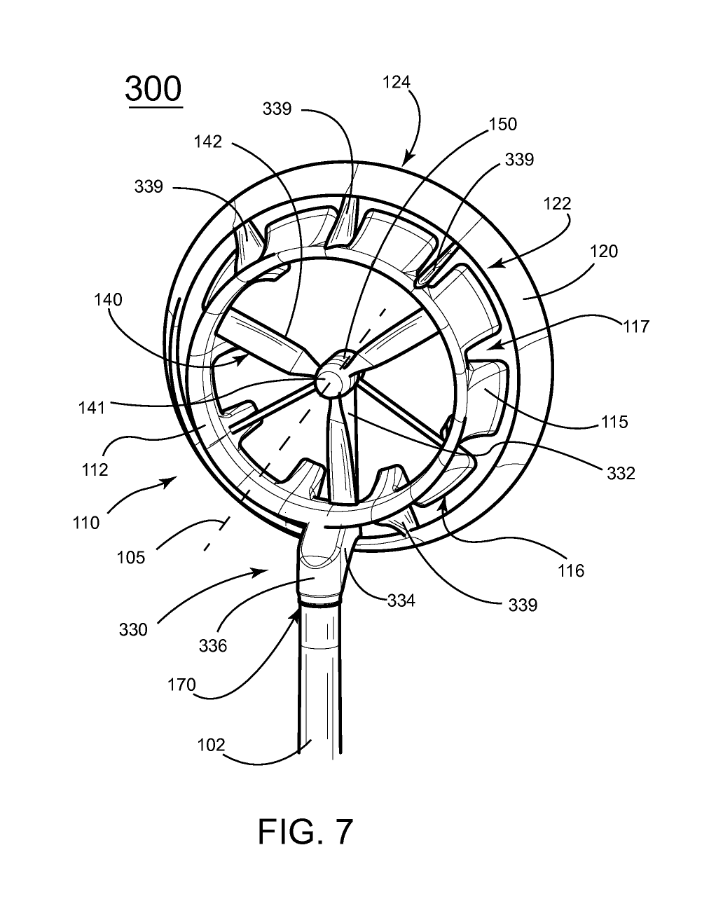

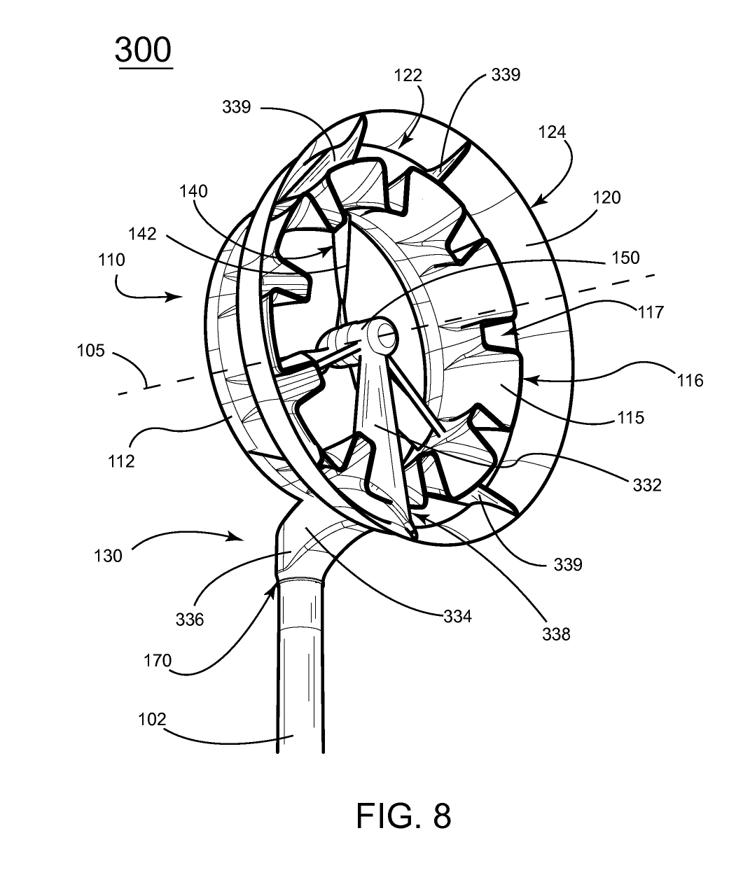

With reference to FIGS. 7 and 8, front and rear perspective views, respectively, of an example embodiment of a shrouded fluid turbine 300 (hereinafter “shrouded turbine 300”) are provided. The example shrouded turbine 300 includes some of the components of the shrouded turbine 100 of FIG. 1 (represented by like numeric designations) and further includes a support structure 330. The support structure 330 can include an upper vertical member 332 that engages the nacelle body 150 at the distal end and a horizontal portion 334 at the proximal end. The horizontal portion 334 can be further engaged with a pivoting structure at a forward pivot point 336. The pivot point 336 can be engaged with the upper portion of the tower 102. The support structure 330 can include an aerodynamic horizontal cross section with a leading edge at the forward pivot point 336 and a trailing edge 338, as depicted in FIG. 8, that is downstream of the leading edge 236. The aerodynamic cross sectional form can be integral to the support structure 332 and, e.g., provides vertical stabilization, improves the passive yaw function of the shrouded turbine 300, and the like. The shrouded turbine 300 can include at least two additional aerodynamic forms 339 which can provide vertical stabilization and passive yaw characteristics. In particular, the aerodynamic forms 339 can define neutral aerodynamic cross-sectional forms that provide structural support between the turbine shroud 110 and the ejector shroud 120. For example, the aerodynamic forms 339 can interconnect the turbine shroud 110 to the ejector shroud 120 at areas on the turbine shroud 110 between the mixing lobes.

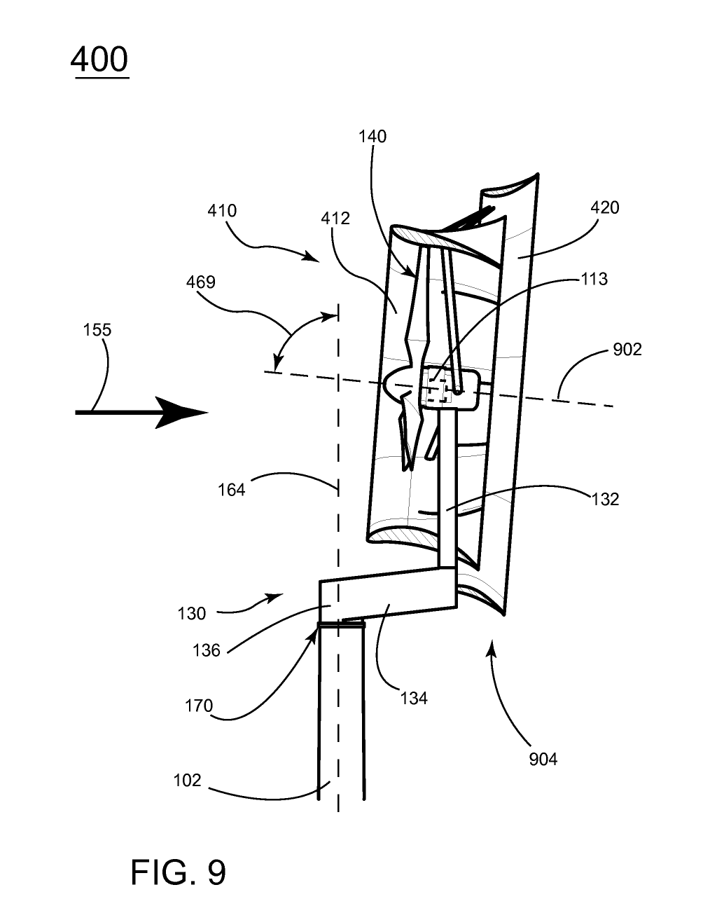

Turning now to FIG. 9, a side view of an example embodiment of a shrouded fluid turbine 400 (herein after “shrouded turbine 400”) is provided. The example shrouded turbine 400 can be structurally similar to the shrouded turbine 100 of FIG. 1, except for the description below. In particular, shrouded turbine 400 includes some of the components of shrouded turbine 100 of FIG. 1 (represented by like numeric designations). However, in contrast to shrouded turbine 100, shrouded turbine 400 is illustrated in FIG. 9 with a centerline 902 that is non-perpendicular to the centerline of the pivot axis 164. The orientation of the pivot axis 164 to the shroud centerline 902 can be such that the angle 469 defined by the intersection of these centerlines is a non-perpendicular angle. In accordance with example embodiments, the resulting effect of the non-perpendicular angle 469 can result in the generation of a positive lift component 904. The positive lift component 904 can be generated, at least in part, by the turbine shroud 410 or the ejector shroud 420 orientation at an angle 469 that is not perpendicular to the pivot axis 164 and substantially perpendicular to the prevalent fluid direction 155.

The resulting positive lift component 904 may be utilized in offsetting the load applied to the predominantly horizontal portion 134 that is further engaged with a pivoting structure 136. Further, the positive lift component 904 can be used to reduce the bending moment experienced by the tower 102 due to interaction of the predominantly horizontal portion 134 that is further engaged with a pivoting structure 136. However, it should be understood that the non-perpendicular angle of the shroud centerline 902 relative to the pivot axis 164 depicted in FIG. 9 which creates a positive lift component 904 is not intended to be limiting in scope and is solely one example of a suitable arrangement of the shroud centerline 902 relative to the pivot axis 164. In particular, those of ordinary skill in the art should recognize that multiple angles 469 may be utilized in generation and variation of a positive lift component 904. In some example embodiments, alternative angles 469 can be utilized such that a negative lift component (not shown) may be generated. For example, a negative lift component may be beneficial in providing increased force that can be applied in the direction of gravity. Such a configuration may be utilized in firmly anchoring the shrouded turbine 400, e.g., in a tidal application where increased fluid flow 155 would serve to yield an increased force for locating the assembly.

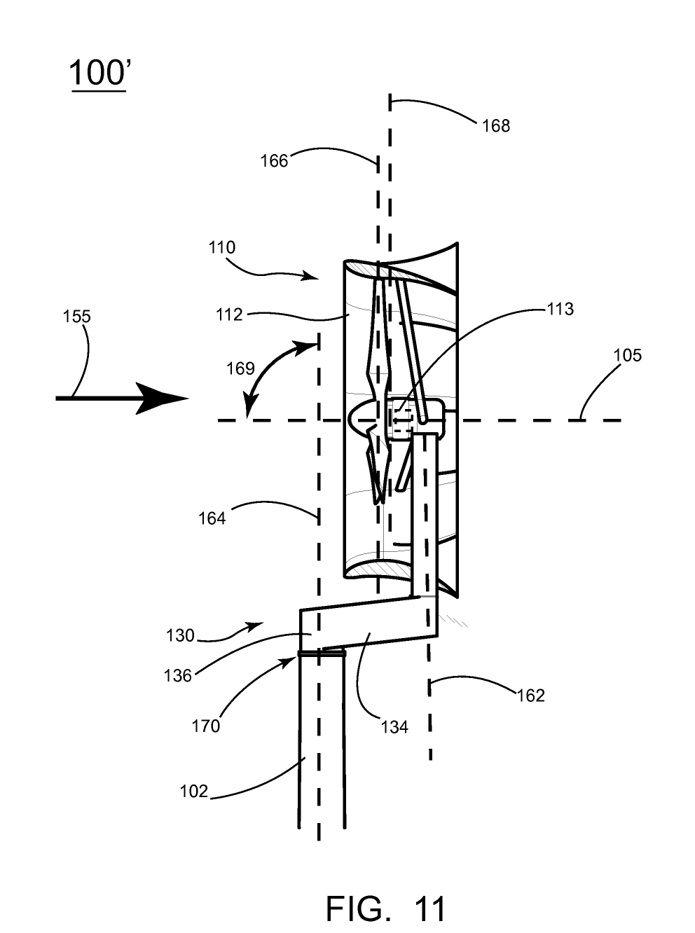

FIGS. 10 and 11 depict an example embodiment of a shrouded turbine 100′ having a single turbine shroud 110. In particular, the example shrouded turbine 100′ includes some of the components of shrouded turbine 100 (represented by like numeric designations), except that shrouded turbine 100′ is free of an ejector shroud 120 and the components associated with the ejector shroud 120. Thus, it should be understood that the example shrouded turbine 100′ can be provided without an ejector shroud 120 and support members 106 for securing the turbine shroud 110 relative to the ejector shroud 120, while functioning substantially similarly to the shrouded turbine 100 discussed above. Thus, the example embodiment of the shrouded turbine 100′ also includes passive yawing, as discussed with respect to FIGS. 1, 2 and 4, and active yawing, as discussed with respect to FIGS. 3 and 4.

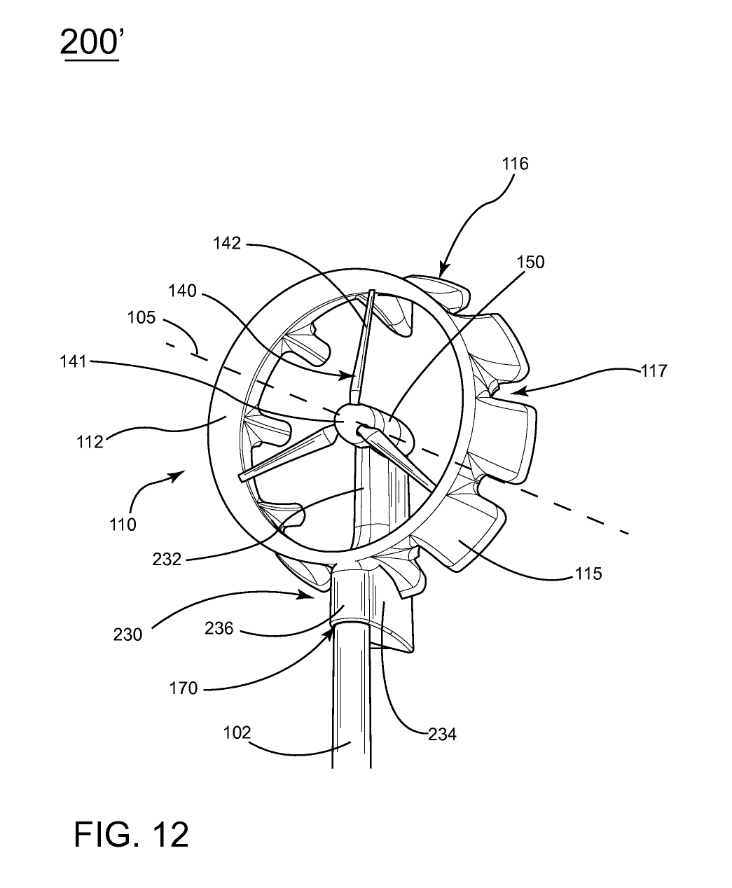

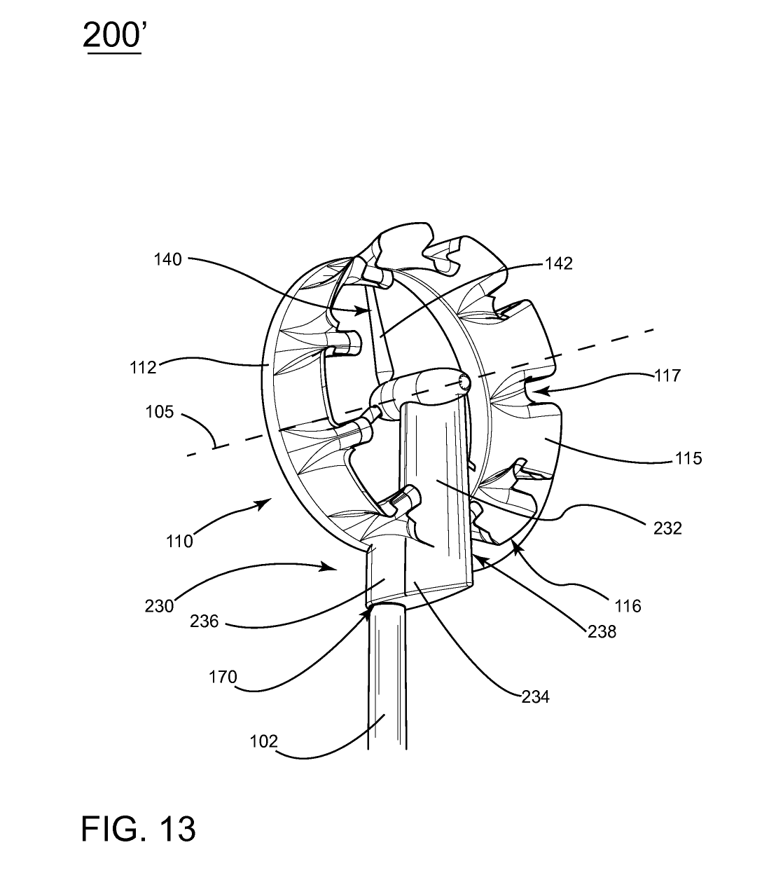

FIGS. 12 and 13 depict an example embodiment of a shrouded turbine 200′ having a single turbine shroud 110. In particular, the example shrouded turbine 200′ includes some of the components of shrouded turbine 200 (represented by like numeric designations), except that shrouded turbine 200′ is free of an ejector shroud 120 and the components associated with the ejector shroud 120. Thus, it should be understood that the example shrouded turbine 200′ can be provided without an ejector shroud 120 and aerodynamic forms 239 for securing the turbine shroud 110 relative to the ejector shroud 120, while functioning substantially similarly to the shrouded turbine 200 discussed above. In some example embodiments, the shrouded turbine 200′ can be provided without an ejector shroud 120 and with aerodynamic forms 239 for assisting in passive yaw of the shrouded turbine 200′. Thus, the example embodiment of the shrouded turbine 200′ also includes passive yawing, as discussed with respect to FIGS. 1, 2 and 4, and active yawing, as discussed with respect to FIGS. 3 and 4.

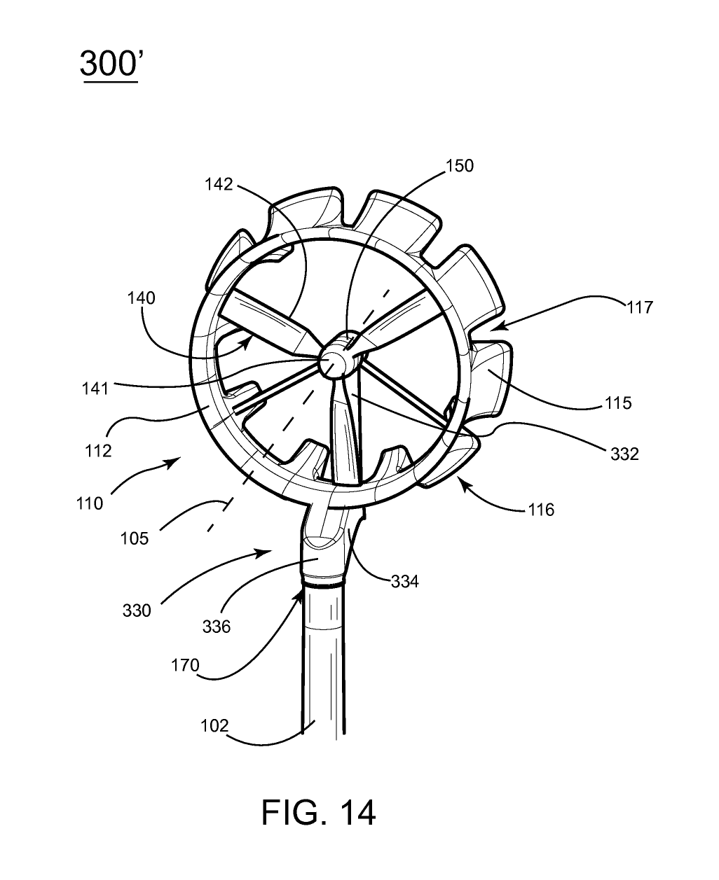

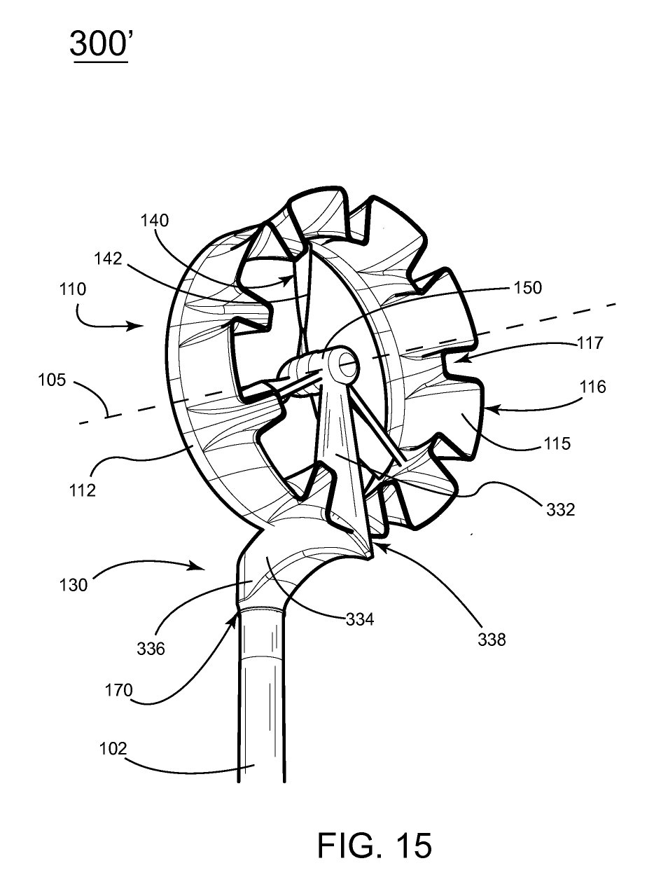

FIGS. 14 and 15 depict an example embodiment of a shrouded turbine 300′ having a single turbine shroud 110. In particular, the example shrouded turbine 300′ includes some of the components of shrouded turbine 300 (represented by like numeric designations), except that shrouded turbine 300′ is free of an ejector shroud 120 and the components associated with the ejector shroud 120. Thus, it should be understood that the example shrouded turbine 300′ can be provided without an ejector shroud 120 and aerodynamic forms 339 for securing the turbine shroud 110 relative to the ejector shroud 120, while functioning substantially similarly to the shrouded turbine 300 discussed above. In some example embodiments, the shrouded turbine 300′ can be provided without an ejector shroud 120 and with aerodynamic forms 339 for assisting in passive yaw of the shrouded turbine 300′. Thus, the example embodiment of the shrouded turbine 300′ also includes passive yawing, as discussed with respect to FIGS. 1, 2 and 4, and active yawing, as discussed with respect to FIGS. 3 and 4.

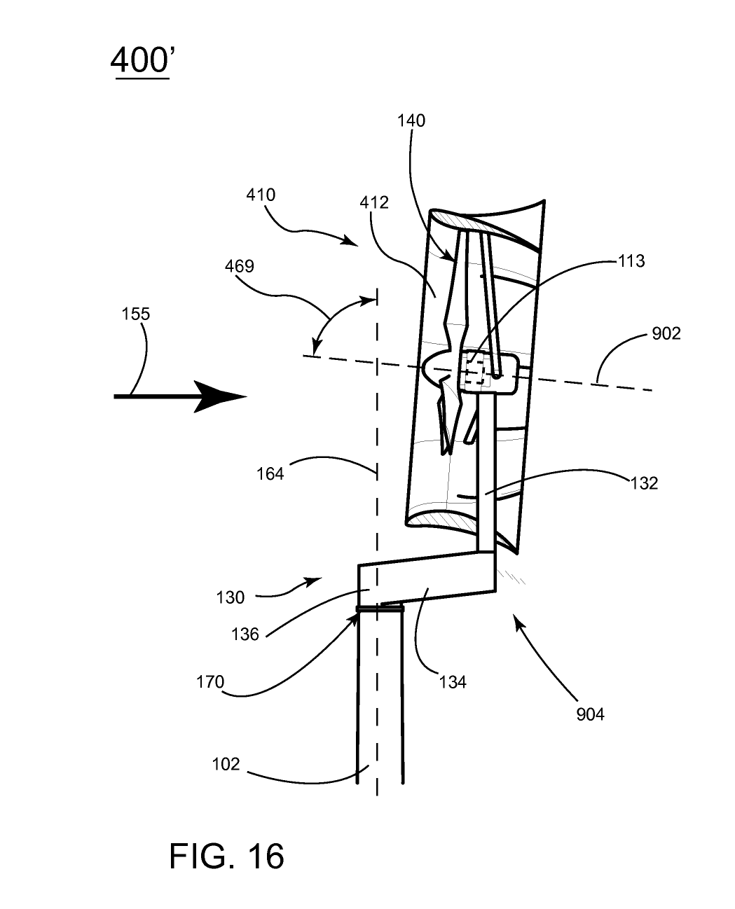

FIG. 16 depicts an example embodiment of a shrouded turbine 400′ having a single turbine shroud 110. In particular, the example shrouded turbine 400′ includes some of the components of shrouded turbine 400 (represented by like numeric designations), except that shrouded turbine 400′ is free of an ejector shroud 120 and the components associated with the ejector shroud 120. Thus, it should be understood that the example shrouded turbine 400′ can be provided without an ejector shroud 120 and support members 106 for securing the turbine shroud 110 relative to the ejector shroud 120, while functioning substantially similarly to the shrouded turbine 400 discussed above. The example embodiment of the shrouded turbine 400′ also includes passive yawing, as discussed with respect to FIGS. 1, 2 and 4, and active yawing, as discussed with respect to FIGS. 3 and 4.

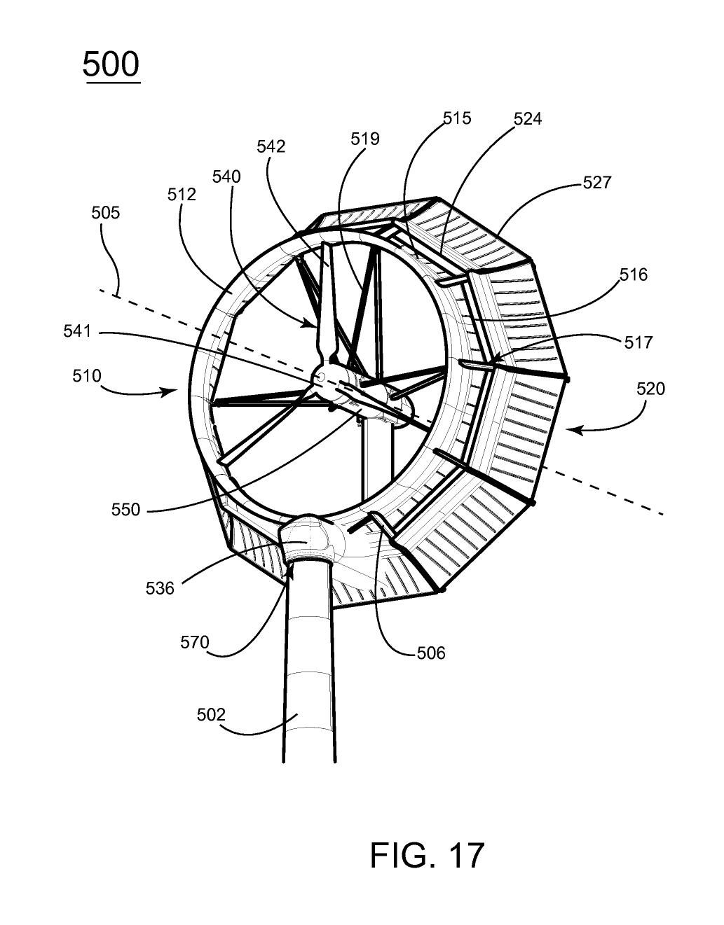

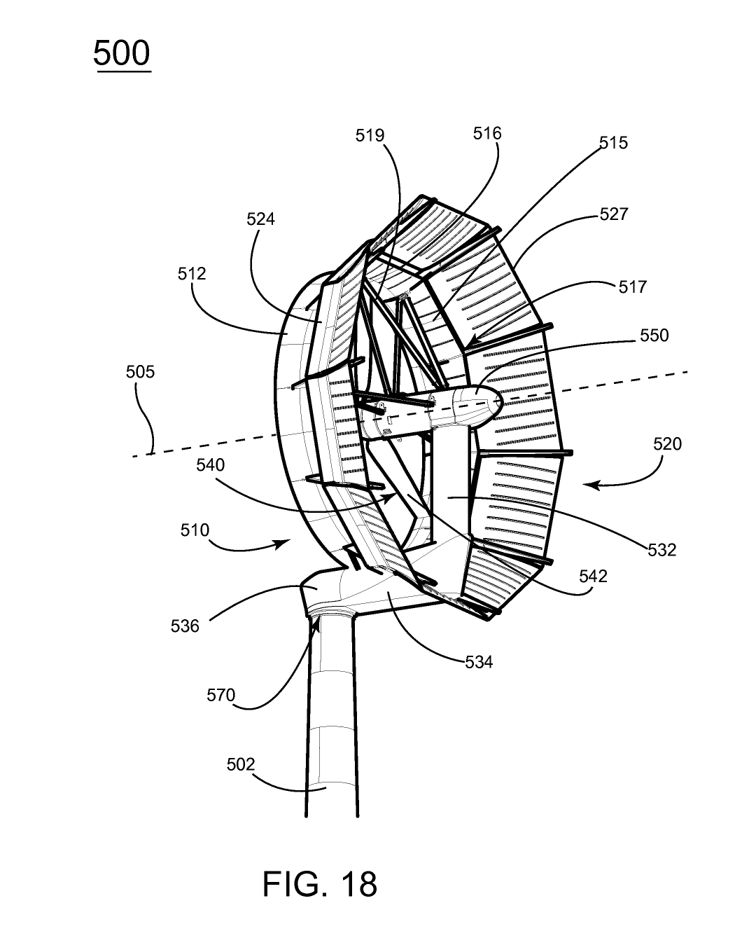

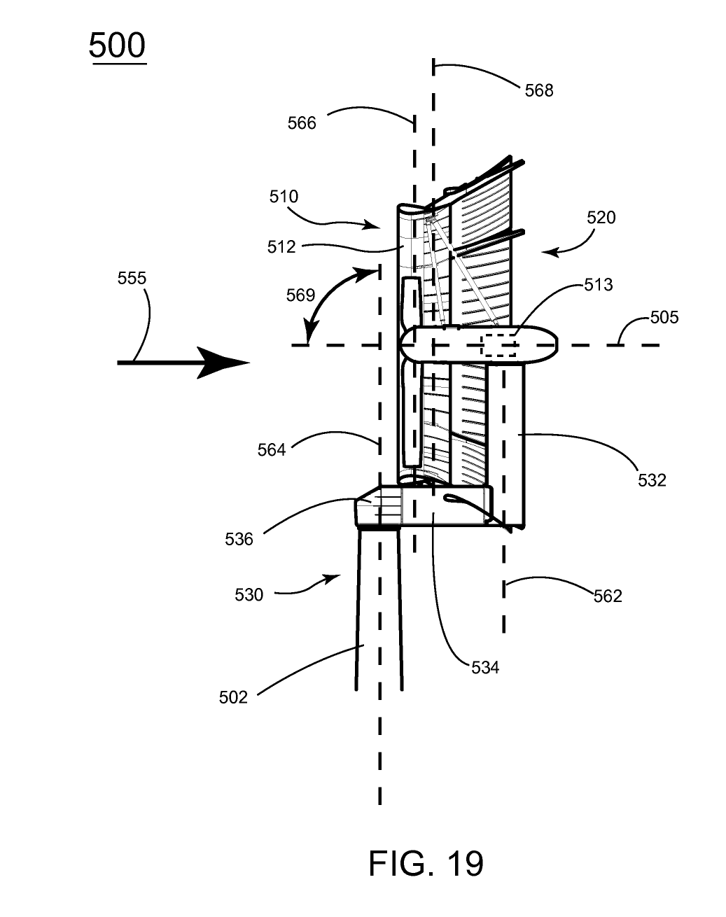

FIGS. 17 and 18 are front and rear perspective views, respectively, of an example embodiment of a shrouded turbine 500 including example airfoils, i.e., an example turbine shroud 510 and an example ejector shroud 520. FIG. 19 is a side view of an example embodiment of a shrouded turbine 500 and illustrates the location of a center of gravity 562, a center of pressure 568 and a pivot axis 564 of the shrouded turbine 500 for the passive yaw system.

With reference to FIGS. 17-19, the shrouded fluid turbine 500 includes a turbine shroud 510, a nacelle body 550, a rotor 540 and an ejector shroud 520. The turbine shroud 510 and the ejector shroud 520 can define a faceted edges or sides. Although illustrated as a dual shroud turbine 500, i.e., a shrouded turbine including the turbine shroud 510 and the ejector shroud 520, in some embodiments, the turbine 500 can be a single shroud turbine, i.e., a shrouded turbine including the turbine shroud 510 and free of the ejector shroud 520. The turbine shroud 510 includes a front end 512, e.g., an inlet or a leading edge. The turbine shroud 510 further includes a rear end 516, e.g., an exhaust end or a trailing edge. The rear end 516 includes substantially linear segments 515 joined at nodes 517. In some embodiments, the rear end 516 of the turbine shroud 510 can include a multi-sided polygon shape having a faceted structure. For example, the rear end 516 can include facets, i.e., linear segments 515, enjoined at nodes 517. The ejector shroud 510 includes a front end 524, e.g., an inlet end or a leading edge, and a rear end 527, e.g., an exhaust end or a trailing edge. The ejector shroud 510 can include a faceted annular airfoil for which the front end 524. In some example embodiments, the rear end 527 of the ejector shroud 520 can include a multi-sided polygon shape having a faceted structure. For example, the rear end 527 can include facets enjoined at nodes. Support members 506 can connect the turbine shroud 510 to the ejector shroud 520. Support members 519 can connect the turbine shroud 510 to the nacelle body 550.

The rotor 540 surrounds the nacelle body 550 and includes a central hub 541 at the proximal end of the rotor blades 542. The nacelle body 550 can include electrical generation equipment 513 located therein. The central hub 541 can be rotationally engaged with the nacelle body 550. The rotor 540, the turbine shroud 510 and the ejector shroud 520 can be coaxial relative to each other, i.e., the rotor 540, the turbine shroud 510 and the ejector shroud 520 can share a common central axis 505. The support structure 530 can include an upper vertical member 532 engaged at the distal end with the nacelle body 550. The support structure 530 can be further engaged at the proximal end with a predominantly horizontal portion 534. The horizontal portion 534 can be engaged with a pivoting structure 536. The pivot point of the pivoting structure 536 can, in turn, be engaged with the upper portion of the tower 502. The tower 502 thereby rotationally supports the components of the shrouded turbine 500.

With specific reference to FIG. 19, the locations of the center of gravity 562, the pivot axis 564, the rotor plane 566 and the center of pressure 568, each approximated by dotted lines, are depicted. The center of pressure 568 can be downstream of the rotor plane 566. The pivot axis 564 located at the center of the tower 502 can be offset from the center of pressure 568. In addition, the pivot axis 564 can be positioned at a perpendicular angle relative to the central axis 505 of the shrouded turbine 500, i.e., angle 569 can be approximately 90°. In some example embodiments, the centerline 505 can be non-perpendicular to the pivot axis 564. The orientation of the pivot axis 564 relative to the shroud centerline 505 can be such that the angle 569 defined by the intersection of these centerlines is a non-perpendicular angle. In accordance with example embodiments, the resulting effect of the non-perpendicular angle 569 can result in the generation of a positive lift component, as discussed above. The positive lift component can be generated, at least in part, by the turbine shroud 510 or the ejector shroud 520 orientation at an angle 569 that is not perpendicular to the pivot axis 564 and substantially perpendicular to the prevalent fluid direction 555. With the center of pressure 568 offset from the pivot axis 564, a fluid stream, represented by the solid arrow 555, can exert a force on the shrouded turbine 500. The force can move the shrouded turbine 500 downstream from the pivot axis 564. Thus, the shrouded turbine 500 can be passively yawed such that it faces the fluid-flow direction. In particular, the location of the pivot axis 564 offset from the center of pressure 568 passively yaws the shrouded turbine 500 to maintain the ejector shroud 520 downstream of the front end 512 of the turbine shroud 510. Thus, the example embodiment of the shrouded turbine 500 also includes passive yawing, as discussed with respect to FIGS. 1, 2 and 4, and can include an active yawing system 570, as discussed with respect to FIGS. 3 and 4.

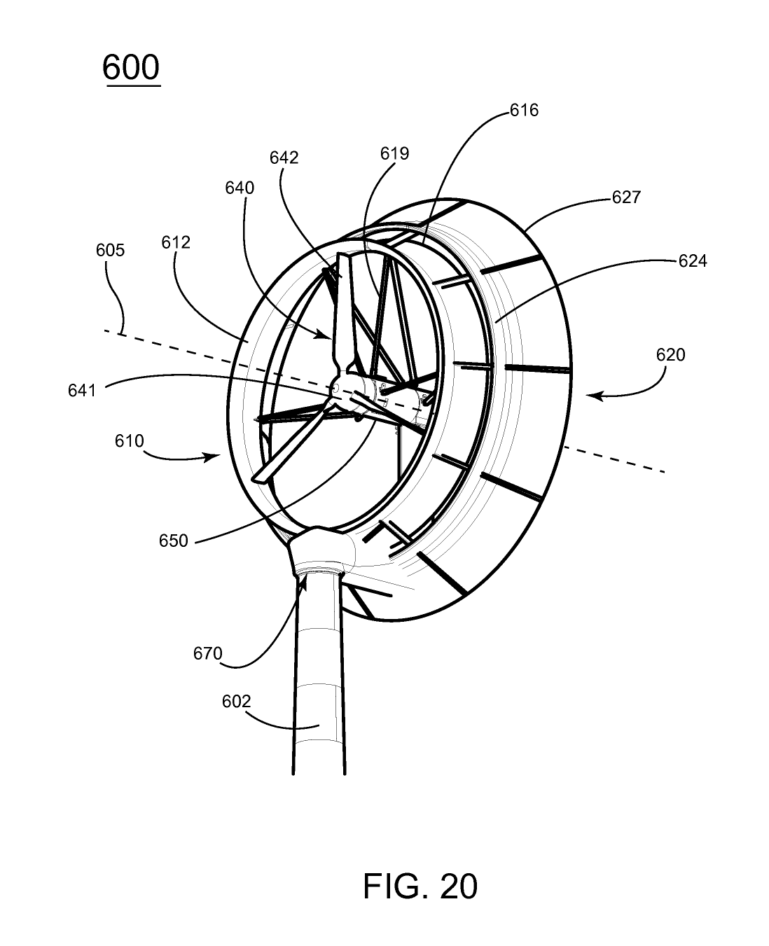

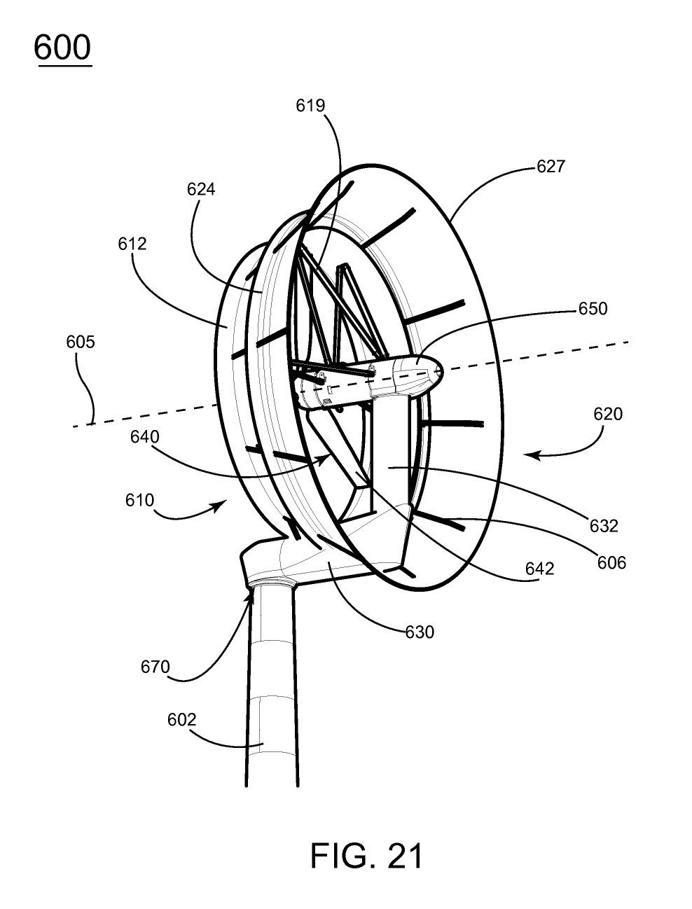

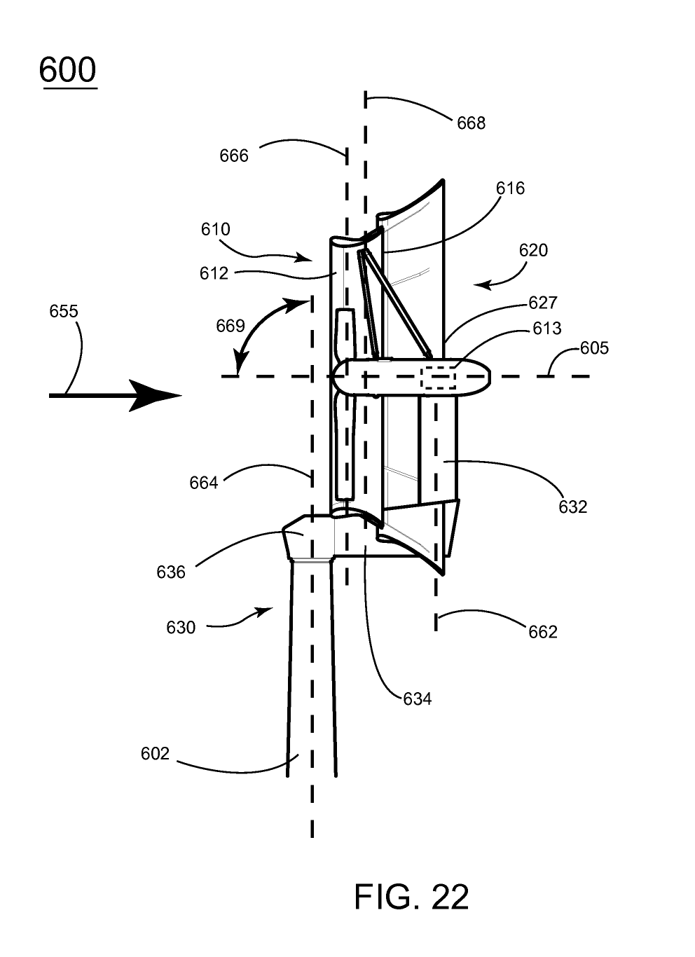

FIGS. 20 and 21 are front and rear perspective views, respectively, of an example embodiment of a shrouded turbine 600 including example airfoils, i.e., an example turbine shroud 610 and an example ejector shroud 620. FIG. 22 is a side view of an example embodiment of a shrouded turbine 600 and illustrates the location of a center of gravity 662, a center of pressure 668 and a pivot axis 664 of the shrouded turbine 600 for the passive yaw system.

With reference to FIGS. 20-22, the shrouded fluid turbine 600 includes a turbine shroud 610, a nacelle body 650, a rotor 640 and an ejector shroud 620. The turbine shroud 610 and the ejector shroud 620 can define a faceted edges or sides. Although illustrated as a dual shroud turbine 600, i.e., a shrouded turbine including the turbine shroud 610 and the ejector shroud 620, in some embodiments, the turbine 600 can be a single shroud turbine, i.e., a shrouded turbine including the turbine shroud 610 and free of the ejector shroud 620. The turbine shroud 610 includes a front end 612, e.g., an inlet or a leading edge. The turbine shroud 610 further includes a rear end 616, e.g., an exhaust end or a trailing edge. The rear end 616 includes a substantially linear segments 615 joined at nodes 617. The ejector shroud 610 includes a front end 624, e.g., an inlet end or a leading edge, and a rear end 627, e.g., an exhaust end or a trailing edge. Support members 606 can connect the turbine shroud 610 to the ejector shroud 620. Support members 619 can connect the turbine shroud 610 to the nacelle body 650.

The rotor 640 surrounds the nacelle body 650 and includes a central hub 641 at the proximal end of the rotor blades 642. The nacelle body 650 can include electrical generation equipment 613 located therein. The central hub 641 can be rotationally engaged with the nacelle body 650. The rotor 640, the turbine shroud 610 and the ejector shroud 620 can be coaxial relative to each other, i.e., the rotor 640, the turbine shroud 610 and the ejector shroud 620 can share a common central axis 605. The support structure 630 can include an upper vertical member 632 engaged at the distal end with the nacelle body 650. The support structure 630 can be further engaged at the proximal end with a predominantly horizontal portion 634. The horizontal portion 634 can be engaged with a pivoting structure 636. The pivot point of the pivoting structure 636 can, in turn, be engaged with the upper portion of the tower 602. The tower 602 thereby rotationally supports the components of the shrouded turbine 600.

With specific reference to FIG. 22, the locations of the center of gravity 662, the pivot axis 664, the rotor plane 666 and the center of pressure 668, each approximated by dotted lines, are depicted. The center of pressure 668 can be downstream of the rotor plane 666. The pivot axis 664 located at the center of the tower 602 can be offset from the center of pressure 668. In addition, the pivot axis 664 can be positioned at a perpendicular angle relative to the central axis 605 of the shrouded turbine 600, i.e., angle 669 can be approximately 90°. In some example embodiments, the centerline 605 can be non-perpendicular to the pivot axis 664. The orientation of the pivot axis 664 relative to the shroud centerline 605 can be such that the angle 669 defined by the intersection of these centerlines is a non-perpendicular angle. In accordance with example embodiments, the resulting effect of the non-perpendicular angle 669 can result in the generation of a positive lift component, as discussed above. The positive lift component can be generated, at least in part, by the turbine shroud 610 or the ejector shroud 620 orientation at an angle 669 that is not perpendicular to the pivot axis 664 and substantially perpendicular to the prevalent fluid direction 655. With the center of pressure 668 offset from the pivot axis 664, a fluid stream, represented by the solid arrow 655, can exert a force on the shrouded turbine 600. The force can move the shrouded turbine 600 downstream from the pivot axis 664. Thus, the shrouded turbine 600 can be passively yawed such that it faces the fluid-flow direction. In particular, the location of the pivot axis 664 offset from the center of pressure 668 passively yaws the shrouded turbine 600 to maintain the ejector shroud 620 downstream of the front end 612 of the turbine shroud 610. Thus, the example embodiment of the shrouded turbine 600 also includes passive yawing, as discussed with respect to FIGS. 1, 2 and 4, and can include an active yawing system 670, as discussed with respect to FIGS. 3 and 4.

While example embodiments have been described herein, it is expressly noted that these embodiments should not be construed as limiting, but rather that additions and modifications to what is expressly described herein also are included within the scope of the invention. Moreover, it is to be understood that the features of the various embodiments described herein are not mutually exclusive and can exist in various combinations and permutations, even if such combinations or permutations are not made express herein, without departing from the spirit and scope of the invention.

1. A shrouded fluid turbine, comprising:
a turbine shroud including an inlet, an outlet and a plurality of mixer lobes circumferentially spaced about the outlet,
a rotor disposed within the turbine shroud and downstream of the inlet, the rotor including a hub and at least one rotor blade engaged with the hub, and
a passive yaw system for regulating a yaw of the shrouded fluid turbine,
wherein the shrouded fluid turbine defines a center of gravity and a center of pressure, the center of gravity being offset from the center of pressure.

2. The shrouded fluid turbine according to claim 1, further comprising an ejector shroud surrounding the plurality of mixer lobes, the ejector shroud defining an ejector shroud inlet and an ejector shroud outlet.

3. The shrouded fluid turbine according to claim 2, wherein the plurality of mixer lobes extend downstream of the ejector shroud inlet.

4. The shrouded fluid turbine according to claim 2, further comprising a support structure for connecting the turbine shroud to the ejector shroud.

5. The shrouded fluid turbine according to claim 4, wherein the support structure provides vertical stabilization to the ejector shroud relative to the turbine shroud and provides yaw characteristics that support passive yaw of the shrouded fluid turbine.

6. The shrouded fluid turbine according to claim 1, wherein the turbine shroud is aerodynamically contoured.

7. The shrouded fluid turbine according to claim 1, further comprising a nacelle including therein electrical generation equipment.

8. The shrouded fluid turbine according to claim 1, further comprising a support structure rotationally engaged with the shrouded fluid turbine.

9. The shrouded fluid turbine according to claim 1, further comprising an active yaw system for yawing the shrouded fluid turbine into a fluid-flow direction.

10. The shrouded fluid turbine according to claim 9, wherein the passive yaw system is a continuous-passive yaw system and the active yaw system is at least one of a momentary-active yaw system, a controlling-active yaw system and a supporting-active yaw system.

11. The shrouded fluid turbine according to claim 10, wherein the passive yaw system is engaged from a cut-in fluid velocity to a cut-out fluid velocity, the controlling-active yaw system is engaged from the cut-in fluid velocity to a predetermined fluid velocity range, and a combination of the passive yaw system and the supporting-active yaw system is engaged between the predetermined fluid velocity range and the cut-out fluid velocity.

12. The shrouded fluid turbine according to claim 11, where the predetermined fluid velocity range is between 8 m/s and 12 m/s.

13. The shrouded fluid turbine according to claim 9, wherein the active yaw system further comprises brakes.

14. The shrouded fluid turbine according to claim 13, wherein the brakes automatically disengage during a loss of grid power to the shrouded fluid turbine.

15. The shrouded fluid turbine according to claim 2, wherein at least one of the turbine shroud and the ejector shroud includes faceted sides.

16. A method of yawing a shrouded fluid turbine, comprising:
providing a shrouded fluid turbine, the shrouded fluid turbine including (i) a turbine shroud including an inlet, an outlet and a plurality of mixer lobes circumferentially spaced about the outlet, (ii) a rotor disposed within the turbine shroud and downstream of the inlet, the rotor including a hub and at least one rotor blade engaged with the hub, and (iii) a passive yaw system for regulating a yaw of the shrouded fluid turbine, wherein the shrouded fluid turbine defines a center of gravity and a center of pressure, the center of gravity being offset from the center of pressure, and
yawing the shrouded fluid turbine via the passive yaw system.

17. The method according to claim 16, further comprising providing an active yaw system.

18. The method according to claim 17, wherein the passive yaw system and the active yaw system yaw the shrouded fluid turbine into a fluid-flow direction.

19. The method according to claim 18, wherein the passive yaw system is a continuous-passive yaw system and the active yaw system is at least one of a momentary-active yaw system, a controlling-active yaw system and a supporting-active yaw system.

20. The method according to claim 19, wherein engaging the passive yaw system from a cut-in fluid velocity to a cut-out fluid velocity, engaging the controlling-active yaw system from the cut-in fluid velocity to a predetermined fluid velocity range, and engaging a combination of the passive yaw system and the supporting-active yaw system between the predetermined fluid velocity range and the cut-out fluid velocity.
